(19) United States
(12) Patent Application Publication
(10) Pub. No.: US 2006/0050199 A1
(43) Pub. Date: Mar. 9, 2006

(54) Double-sided liquid crystal display device

(75) Inventors: Mu-Chi Hsu, Tu-Cheng (TW); Tung-Ming Hsu, Tu-Cheng (TW); Chien-Min Chen, Tu-Cheng (TW); Ming-Fu Hsu, Tu-Cheng (TW); Wen-Feng Cheng, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/220,330

(22) Filed: Sep. 6, 2005

(30) Foreign Application Priority Data
Sep. 3, 2004 (TW) 93126632

(51) Int. Cl. G02F 1/1335

(52) U.S. Cl. 349/64

(57) ABSTRACT

A liquid crystal display device (20) includes two liquid crystal display panels (25, 26) and a backlight module sandwiched between the two liquid crystal display panels. The backlight module includes a first light guide plate (23), a second light guide plate (24), a light source (21) disposed adjacent to the first and second light guide plates, and a double-sided reflecting plate (22) sandwiched between the first and second light guide plates. The liquid crystal display device includes the double-sided reflecting plate, which is sandwiched between the first and second light guide plates, and can reflect light beams from the light source toward the first and second light guide plates. The first and second light guide plates, which are pressuredly pressed together by molds with the reflecting plate to form the backlight module, are two independent optical members, and do not affect each other. Therefore, the liquid crystal display device has good display quality.

### BACKGROUND

1. Field of the Invention

The present invention relates to a double-sided liquid crystal display (LCD) device, and a backlight module used therein.

2. General Background

Different kinds of LCD devices have been used in a variety of applications. A double-sided LCD device has front and rear LCD panels, which are coupled together back-to-back. The LCD panels used in the double-sided LCD device generally have the same size. The double-sided LCD device further includes a double-sided emitting backlight module disposed between the front and rear LCD panels.

Referring to FIG. 7, a double-sided emitting backlight module typically includes an upper film 12, a light guide plate 13, a lower film 14, and a masking plate 15 in that order. The light guide plate 13 includes an incident surface 131, and two opposite emitting surfaces 132 which face the upper film 12 and the lower film 14 respectively. A plurality of light sources 11 is disposed adjacent to the incident surface 131. After light beams emitted from the light sources 11 enter the light guide plate 13 through the incident surface 131, they separate into two parts. The two parts of the light beams leave the light guide plate 13 from the two emitting surfaces 132, and enter the upper film 12 and the lower film 14 respectively. When the light beams respectively propagate through the upper and lower films 12, 14, the light beams define a first illuminating region (not labeled) on the upper film 12 and a second illuminating region 16 on the masking plate 15. Thereafter the light beams transmit toward two liquid crystal display panels (not shown), respectively.

A thickness of the light guide plate 13 is generally in the range from 0.5˜0.8 mm, which adds to the overall thickness of the backlight module 10. The upper and lower films 12, 14 are transflective. When proportions of the first and second illuminating regions are not identical due to different display regions, sizes of the upper and lower films 12, 14 need to be adjusted. Consequently, a “shadow” 17 of the smaller of the films (for example, the lower film 14) is visible at the larger illuminating region (for example, the first illuminating region, not labeled). The shadow 17 degrades the display quality of the corresponding liquid crystal display panel.

What is needed, therefore, is a liquid crystal display having good display quality.

### SUMMARY

In a preferred embodiment of the present invention, a liquid crystal display device includes two liquid crystal display panels and a backlight module sandwiched between the two liquid crystal display panels. The backlight module includes a first light guide plate, a second light guide plate, a light source, and a double-sided reflecting plate sandwiched between the first and second light guide plates. The light source is disposed adjacent to the first and second light guide plates. The first light guide plate, the double-sided reflecting plate and the second light guide plate are originally separate components and are pressuredly pressed together by molds to form the backlight module.

The liquid crystal display device includes the double-sided reflecting plate, which is sandwiched between the first and second light guide plates, and can reflect light beams from the light source toward the first and second light guide plates. The first and second light guide plates are two independent optical members, and do not affect each other. Therefore, the liquid crystal display device has good display quality.

Other advantages and novel features of embodiments of the present invention will become more apparent from the following detailed description when taken in conjunction with the accompanying drawings, in which:

### BRIEF DESCRIPTION OF THE DRAWINGS

FIG. 1 is an exploded, isometric cut-away view of a liquid crystal display device according to a first embodiment of the present invention;

FIG. 2 is an exploded, side cut-away view of the liquid crystal display device of FIG. 1;

FIG. 3 is an enlarged view of a circled portion III of FIG. 2;

FIG. 4 is an exploded, isometric cut-away view of a liquid crystal display device according to a second embodiment of the present invention;

FIG. 5 is an isometric view of a first light guide plate of the backlight module of FIG. 4;

FIG. 6 is an enlarged view of a circled portion VI of FIG. 5; and

FIG. 7 is an exploded, isometric view of a conventional backlight module.

### DETAILED DESCRIPTION OF PREFERRED EMBODIMENTS

Reference will now be made to the drawings to describe embodiments of the present invention in detail.

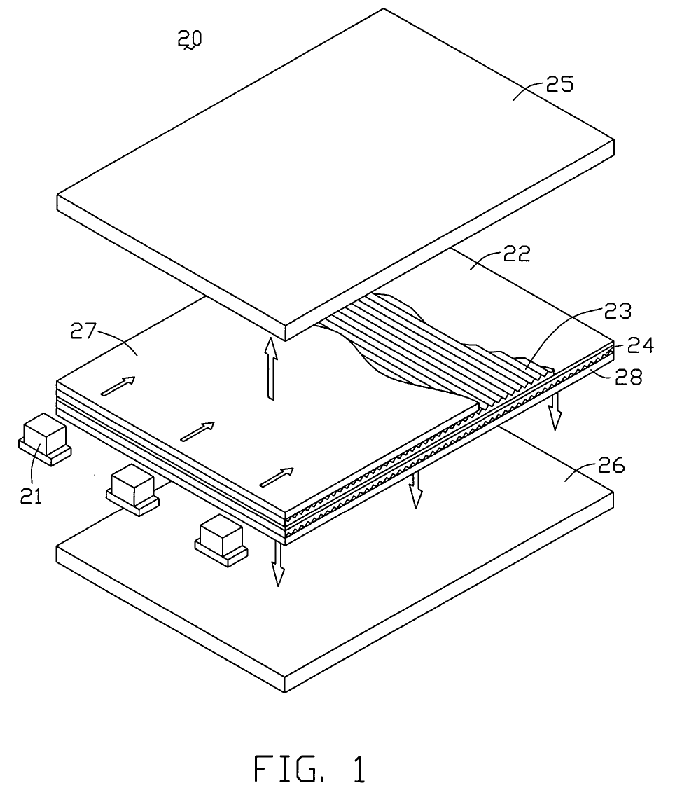

FIG. 1 is an isometric view of a double-sided liquid crystal display device 20 according to a first embodiment of the present invention. The liquid crystal display device 20 includes a first liquid crystal display panel 25, a second liquid crystal display panel 26, and a backlight module sandwiched between the first and second liquid crystal display panels 25, 26. The backlight module includes a plurality of light sources 21, a first plate-like light guide member 23, a second plate-like light guide member 24, a reflector like a double-sided reflecting plate 22 sandwiched between the first and second light guide plates 23, 24, a first optical film 27, and a second optical film 28. The first light guide plate 23, the double-sided reflecting plate 22 and the second light guide plate 24 are originally separate components and are pressuredly pressed together by molds to form the backlight module.

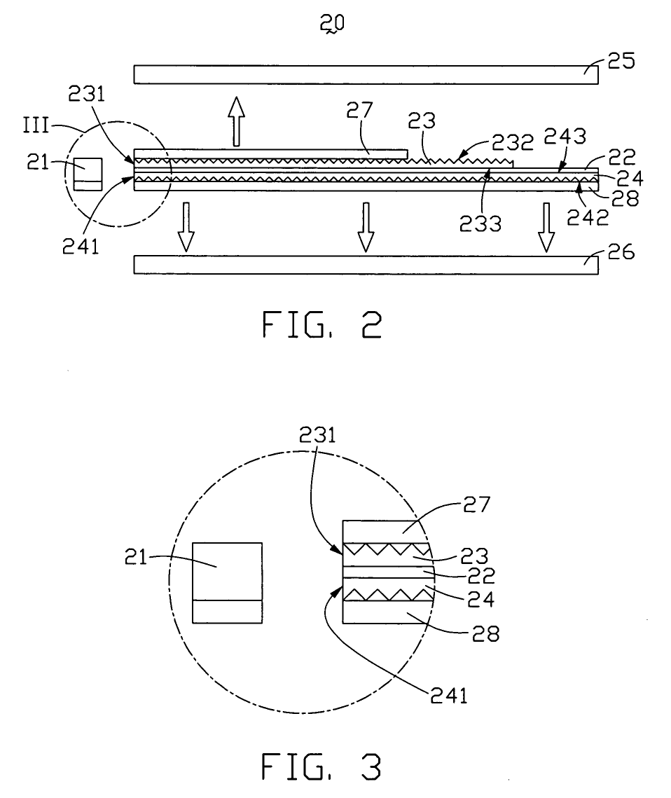

FIG. 2 is a side view of the liquid crystal display device 20, and FIG. 3 is an enlarged view of a circled portion III of FIG. 2. The first and second light guide plates 23, 24 are substantially rectangular, and can be formed by an injection molding method or a hot-pressing method. The first light guide plate 23 includes a first incident surface 231, a first light emitting surface 232 adjacent to the first incident surface 231, and a first bottom surface 233 opposite to the first emitting surface 232. The second light guide plate 24 includes a second light incident surface 241, a second light emitting surface 242 adjacent to the second incident surface 241, and a second bottom surface 243 opposite to the second emitting surface 242. The first and second emitting surfaces 232, 242 both have a plurality of v-shape cuts (not labeled) formed thereat. The v-shape cuts can improve the uniformity of light provided by the liquid crystal display 20.

The light sources 21 can be light emitting diodes (LEDs), and are arranged in a single row adjacent to the first and second incident surfaces 231, 241. The reflecting plate 22 can be a polyethylene terephthalate (PET) substrate having silver coated on both main surfaces thereof. The first optical film 27 is adjacent to the first emitting surface 232, and is sandwiched between the first light guide plate 23 and the first liquid crystal display panel 25. The second optical film 28 is adjacent to the second emitting surface 242, and is sandwiched between the second light guide plate 24 and the second liquid crystal display panel 26.

Light beams emitted from the light sources 21 enter the first and second light guide plates 23, 24 through the first and second incident surfaces 231, 241, respectively. Some of the light beams are then emitted directly from the first and second emitting surfaces 232, 242. Other of the light beams are emitted from the first and second emitting surfaces 232, 242 after being reflected one or more times by the reflecting plate 22. All light beams emitted from the first and second emitting surfaces 232, 242 respectively propagate through the first and second optical films 27, 28, and transmit toward the first and second liquid crystal display panels 25, 26, respectively, thereby achieving a double-sided display.

The liquid crystal display device 20 includes the double-sided reflecting plate 22, which is sandwiched between the first and second light guide plates 23, 24, and can reflect light beams from the light sources 21 toward the first and second light guide plates 23, 24. The first and second light guide plates 23, 24 are two independent optical members, and do not affect each other. Therefore, the liquid crystal display device 20 has good display quality.

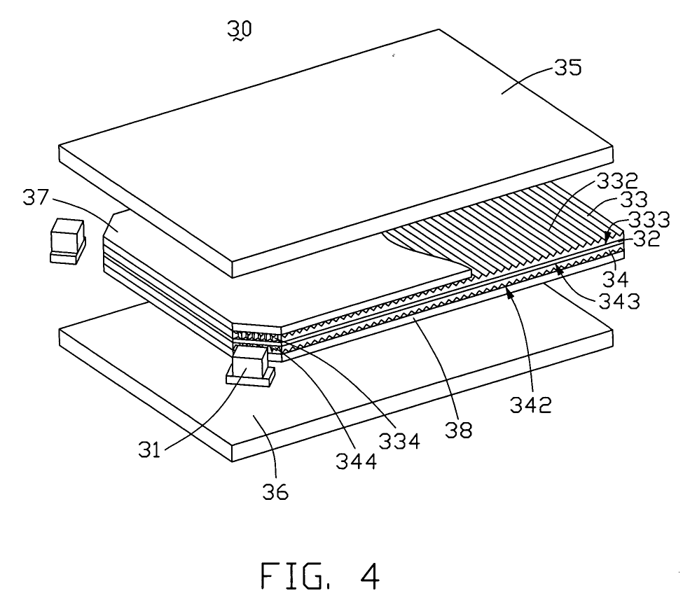

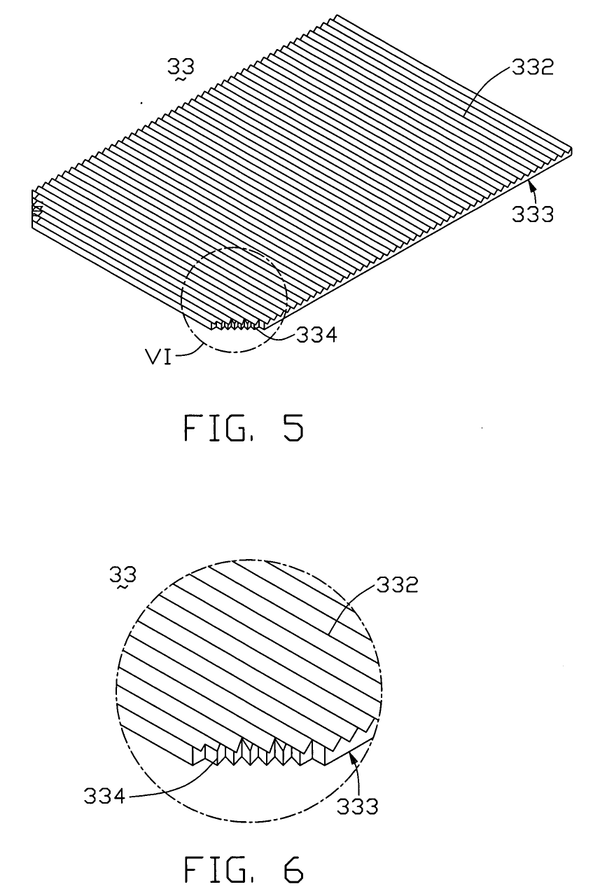

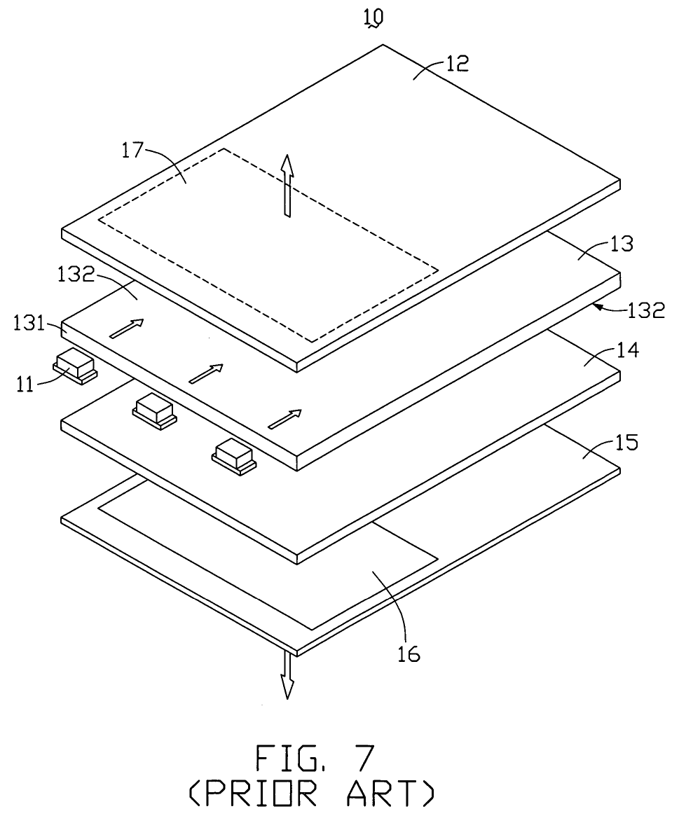

FIG. 4 is an isometric view of a liquid crystal display device 30 according to a second embodiment of the present invention. The liquid crystal display device 30 includes a first liquid crystal display panel 35, a second liquid crystal display panel 36, and a backlight module sandwiched between the first and second liquid crystal display panels 35, 36. The backlight module includes two light sources 31, a first light guide plate 33, a second light guide plate 34, a reflecting plate 32 sandwiched between the first and second light guide plates 33, 34, a first optical film 37, and a second optical film 38.

The first and second light guide plates 33, 34 are substantially rectangular, and can be formed by an injection molding method or a hot-pressing method. The first light guide plate 33 includes a first emitting surface 332, and a first bottom surface 333 opposite to the first emitting surface 332. Two corners of the first light guide plate 33 are bevel-cut, thereby defining two first light incident surfaces 334. The second light guide plate 34 includes a second light emitting surface 342, and a second bottom surface 343 opposite to the second emitting surface 342. Two corners of the second light guide plate 34 are bevel-cut, therefore defining two second light incident surfaces 344. The first and second emitting surfaces 332, 342 each have a plurality of v-shape cuts (not labeled) formed thereat. The v-shape cuts can improve the uniformity of light provided by the liquid crystal display device 30.

The two light sources 31 can be light emitting diodes. Each light sources 31 is arranged adjacent to a corresponding pair of first and second incident surfaces 331, 341. The reflecting plate 32 can be a polyethylene terephthalate substrate having silver coated on both two main surfaces thereof. The first optical film 37 is adjacent to the first emitting surface 332, and is sandwiched between the first light guide plate 33 and the first liquid crystal display panel 35. The second optical film 38 is adjacent to the second emitting surface 342, and is sandwiched between the second light guide plate 34 and the second liquid crystal display panel 36.

Light beams emitted from the light sources 31 enter the first and second light guide plates 33, 34 through the first and second incident surfaces 331, 341. Some of the light beams are then emitted directly from the first and second emitting surfaces 332, 342. Other of the light beams are emitted from the first and second emitting surfaces 332, 242 after being reflected one or more times by the reflecting plate 32. All light beams emitted from the first and second emitting surfaces 332, 342 respectively propagate through the first and second optical films 37, 38, and transmit toward the first and second liquid crystal display panels 25, 26, thereby achieving a double-sided display.

The liquid crystal display device 30 includes the double-sided reflecting plate 32, which is sandwiched between the first and second light guide plates 33, 34, and can reflect light beams from the light sources 31 toward the first and second light guide plates 33, 34. The first and second light guide plates 33, 34 are two independent optical members, and do not affect each other. Therefore, the liquid crystal display device 30 has good display quality.

The present invention may have further and/or alternative embodiments as follows. The light sources 21, 31 of the liquid crystal display device 20, 30 can instead be linear light sources such as cold cathode fluorescent lamps (CCFLs). The reflecting plate 22, 32 can be a polyethylene terephthalate substrate having titanium oxide (TiO₂) coated on both main surfaces thereof, or a polyethylene terephthalate substrate having silver coated on one main surface thereof and titanium oxide coated on the other main surface thereof, or a substrate made from reflective material. A frame may be provided for receiving and retaining the liquid crystal display panels 25, 26 (35, 36) and the backlight module therein.

It is to be further understood that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A backlight module, comprising:
a first light guide plate;
a second light guide plate;
a light source disposed adjacent to the first and second light guide plates; and
a double-sided reflecting plate sandwiched between the first and second light guide plates for reflecting light beams from the light source toward the first and second light guide plates, respectively.

2. The backlight module as claimed in claim 1, wherein the first and second light emitting surfaces each comprise a plurality of v-shape cuts thereat.

3. The backlight module as claimed in claim 1, wherein the light source comprises one of a light emitting diode (LED) and a cold cathode fluorescent lamp (CCFL).

4. The backlight module as claimed in claim 1, wherein the reflecting plate is a polyethylene terephthalate (PET) substrate having reflective material coated on both main surfaces thereof.

5. The backlight module as claimed in claim 4, wherein the reflective material is selected from silver and titanium oxide (TiO₂).

6. The backlight module as claimed in claim 1, wherein the reflecting plate is a polyethylene terephthalate substrate having silver coated on one main surface thereof and titanium oxide coated on the other main surface thereof.

7. The backlight module as claimed in claim 1, wherein the reflecting plate is a substrate made from reflective material.

8. The backlight module as claimed in claim 1, wherein a corner of the first light guide plate is bevel-cut, thereby defining a first light incident surface, and a corner of the second light guide plate is bevel-cut, thereby defining a second light incident surface, and the light source is arranged adjacent to the first and second incident surfaces.

9. A liquid crystal display device, comprising:
two liquid crystal display panels; and
a backlight module sandwiched between the two liquid crystal display panels, comprising:
a first light guide plate;
a second light guide plate;
a light source disposed adjacent to the first and second light guide plates; and
a double-sided reflecting plate sandwiched between the first and second light guide plates for reflecting light beams from the light source toward the first and second light guide plates, respectively.

10. The liquid crystal display device as claimed in claim 9, wherein the first and second light emitting surfaces each comprise a plurality of v-shape cuts thereat.

11. The liquid crystal display device as claimed in claim 9, wherein the light source comprises an item selected from the group consisting of a light emitting diode and a cold cathode fluorescent lamp.

12. The liquid crystal display device as claimed in claim 9, wherein the reflecting plate is a polyethylene terephthalate substrate having reflective material coated on both main surfaces thereof.

13. The liquid crystal display device as claimed in claim 12, wherein the reflective material is selected from silver and titanium oxide (TiO₂).

14. The liquid crystal display device as claimed in claim 9, wherein the reflecting plate is a polyethylene terephthalate substrate having silver coated on one main surface thereof and titanium oxide coated on the other main surface thereof.

15. The liquid crystal display device as claimed in claim 9, wherein the reflecting plate is a substrate made from reflective material.

16. The liquid crystal display device as claimed in claim 9, wherein a corner of the first light guide plate is bevel-cut, thereby defining a first light incident surface, and a corner of the second light guide plate is bevel-cut, thereby defining a second light incident surface, and the light source is arranged adjacent to the first and second incident surfaces.

17. The liquid crystal display device as claimed in claim 9, further comprising a frame receiving the liquid crystal display panels and the backlight module.

18. A display device comprising:
a light source in said display device providing light for said display device; and
a backlight module of said display device disposed next to said light source to receive said light from said light source, said backlight module comprising at least two light guide members integrally formed therein and physically separate by a reflector integrally sandwiched between said at least two light guide members, said light of said light source capable of being transmitted separately and respectively into each of said at least two light guide members, and capable of being reflected respectively by said reflector within said each of said at least two light guide members so as to be emitted out of said each of said at least two light guide members along different directions.

19. The display device as claimed in claim 18, wherein said reflector and said at least two light guide members are pressuredly pressed together to integrally form said backlight module.

20. The display device as claimed in claim 18, wherein said each of at least two light guide members has an emitting surface to emit said light out of said each of at least two light guide members along one of said different directions, a plurality of v-shape cuts is formed on said emitting surface.
